(19) United States
(12) Patent Application Publication
(10) Pub. No.: US 2010/0251154 A1
(43) Pub. Date: Sep. 30, 2010

(54) Electronic Device and Method for Operating Screen

(75) Inventors: Hao-Ying Chang, Taipei City (TW); Jui-Tsen Huang, Taipei City (TW); Da-Yu Yu, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: COMPAL ELECTRONICS, INC., Taipei City (TW)

(21) Appl. No.: 12/749,705

(22) Filed: Mar. 30, 2010

Related U.S. Application Data
(60) Provisional application No. 61/164,918, filed on Mar. 31, 2009.

(51) Int. Cl. G06F 3/048

(52) U.S. Cl. 715/769; 715/862; 715/790; 715/781

(57) ABSTRACT

An electronic device and a method of opening a user interface on a screen are disclosed, wherein the screen is capable of displaying a working window and an executing window. When a pointer is positioned on the executing window, a user interface module can generate a first sensing signal for displaying at least one item on the screen. When the pointer selects the item, the user interface module can generate a second sensing signal. When the pointer drags the item to the working window, the user interface module can generate a third sensing signal. The processing module can continuously receive the first, second and third sensing signals to open a user interface corresponding to the item in the working window, where the user interface is adjacent to the pointer.

### RELATED APPLICATIONS

This application claims priority to U.S. provisional Application Ser. No. 61/164,918, filed Mar. 31, 2009, which is herein incorporated by reference.

### BACKGROUND

1. Technical Field

The present disclosure relates to an electronic device and a method of opening a user interface on a screen.

2. Description of Related Art

With the fast development of the electronics industry and information technology, electronic products have become more popular. Conventionally, many electronic devices, such as computers or mobile phones, have screens.

As to a small electronic device, the touch screen is limited in size. A user comes to grips with this small sized touch screen, so that errors in operation are extremely common. In view of the foregoing, there is an urgent need in the related field to provide a way to operate the screen ergonomically.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more various aspects, the present disclosure is directed to an electronic device and a method of operating a screen.

According to one embodiment of the present invention, the electronic device includes a screen, a user interface module and a processing module. The screen is capable of displaying a working window and an executing window. The user interface module, wherein when a pointer is positioned on the executing window, the user interface module generates a first sensing signal for displaying at least one item on the screen. When the pointer selects the item, the user interface module generates a second sensing signal. When the pointer drags the item to the working window, the user interface module generates a third sensing signal. The processing module can continuously receive the first, second and third sensing signals that are sequentially generated by the user interface module to open a user interface corresponding to the item in the working window, where the user interface is adjacent to the pointer.

According to another embodiment of the present invention, a screen is capable of displaying a working window and an executing window, and a user interface module is capable of generating first, second, and third sensing signals. The method for opening a user interface on a screen includes following steps:

(a) When a pointer is positioned on the executing window, a first sensing signal is generated, and at least one item is displayed;

(b) When the pointer selects the item, a second sensing signal is gendered;

(c) When the pointer drags the item to the working window, a third sensing signal is generated; and

(d) When a processing module continuously receives the first, second and third sensing signals that are sequentially generated by the user interface module, a user interface corresponding to the item is opened in the working window, wherein the user interface is adjacent to the pointer.

When using the electronic device and the method for operating the user interface, a user moves the pointer to the executing window and then drags the item to the working window for opening the user interface corresponding to the item, where the user interface is adjacent to the pointer. This operating manner conforms to ergonomics, so as to provide convenience in use.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIGS. 1a-1b are schematic drawings of an electronic device according to one or more embodiments of the present invention;

FIGS. 2a-2d are schematic drawings of opening a user interface on a screen of the electronic device;

FIGS. 3a-3b are schematic drawings of the electronic device according to a first embodiment of the present invention;

FIGS. 4a-4b are schematic drawings of the electronic device according to a second embodiment of the present invention;

FIG. 5 is a schematic drawing the electronic device according to a third embodiment of the present invention; and

FIG. 6 is a flowchart of a method for opening a user interface on a screen according to one or more embodiments of the present invention.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

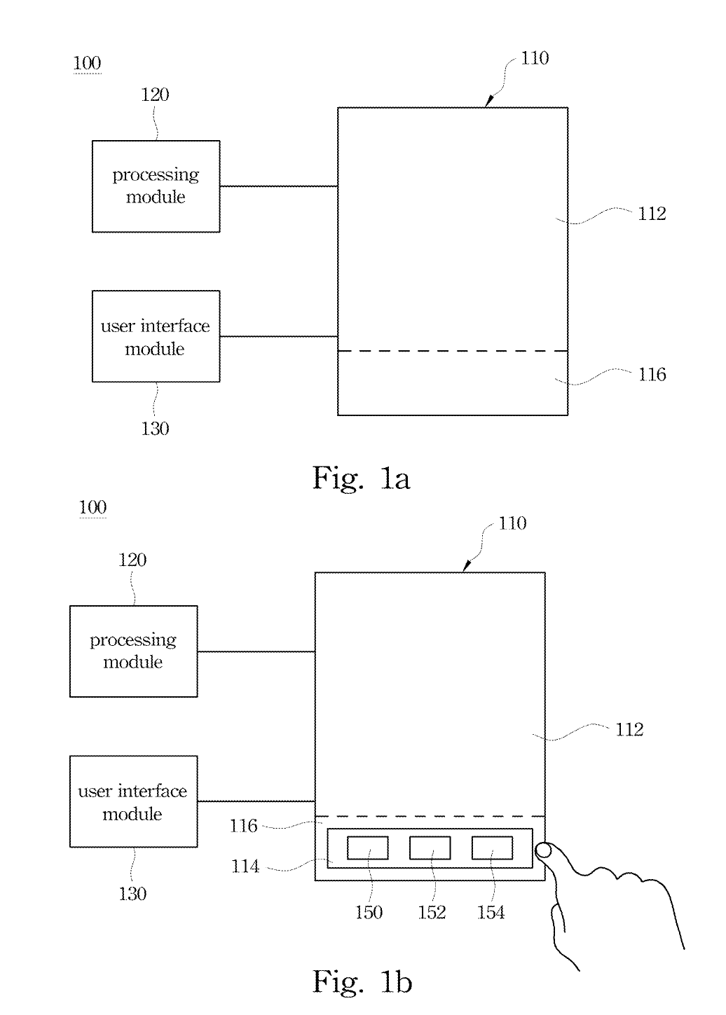

FIG. 1a is a block diagram of an electronic device 100 according to one or more embodiments of the present invention. As shown in FIG. 1a, the electronic device 100 comprises a screen 110, a user interface module 130 and the processing module 120. The screen 110 may be a touch screen, such as a touch interface CRT screen, a touch panel display apparatus, an optical screen or the like. Alternatively, the screen 110 may be a non-touch screen, such as a liquid crystal display, a cathode ray tube (CRT) or the like.

The screen 110 is capable of displaying a working window 112 and an executing window 114. As shown in FIG. 1 a, the screen 110 has a predetermined executing window area 116. When a pointer isn't positioned on the predetermined executing window area 116, the entire display region of the screen 110 serves as the working window 112. As shown in FIG. 1b, the screen 110 displays the working window 112 and the executing window 114 simultaneously when the pointer (finger) is positioned on the predetermined executing window area 116.

Moreover, the screen 110 may display the executing window 114 that is overlapped on the working window 112. Alternatively, the working window 112 is reduced from a first window range (as shown in FIG. 1a) to a second window range (as shown in FIG. 1b), so that the screen 110 displays the working window 112 and the executing window 114 simultaneously.

Additionally or alternatively, the screen 110 may display the working window 112 and the executing window 114 simultaneously without having the predetermined executing window area 116.

During the screen 110 displays a frame, the working window 112 is used for displaying an application program interface, an icon or the like, so that a user can operate the electronic device 100 through the working window 112 of the screen 110. The executing window 114 functions as a menu for displaying a special item instruction or an express instruction that the user defined.

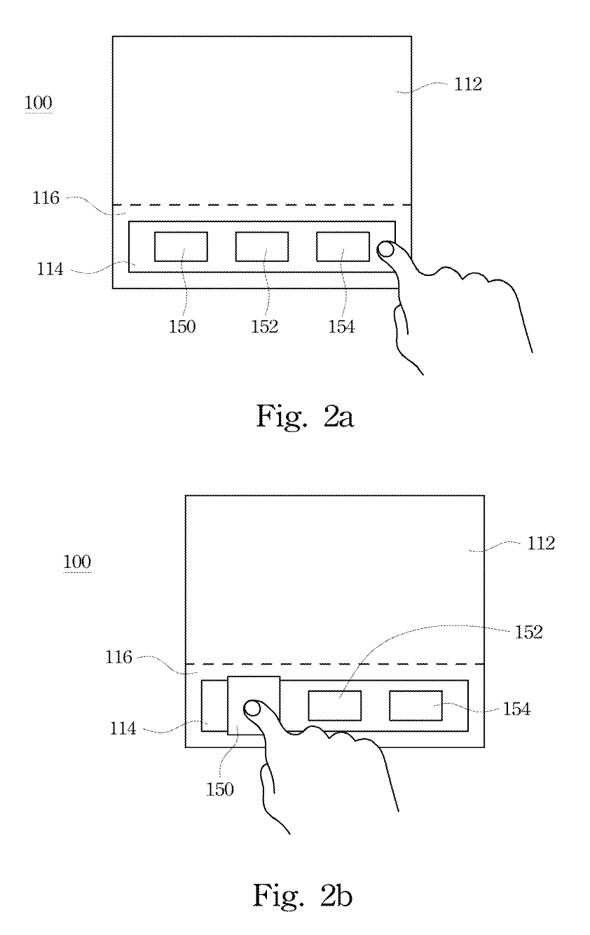

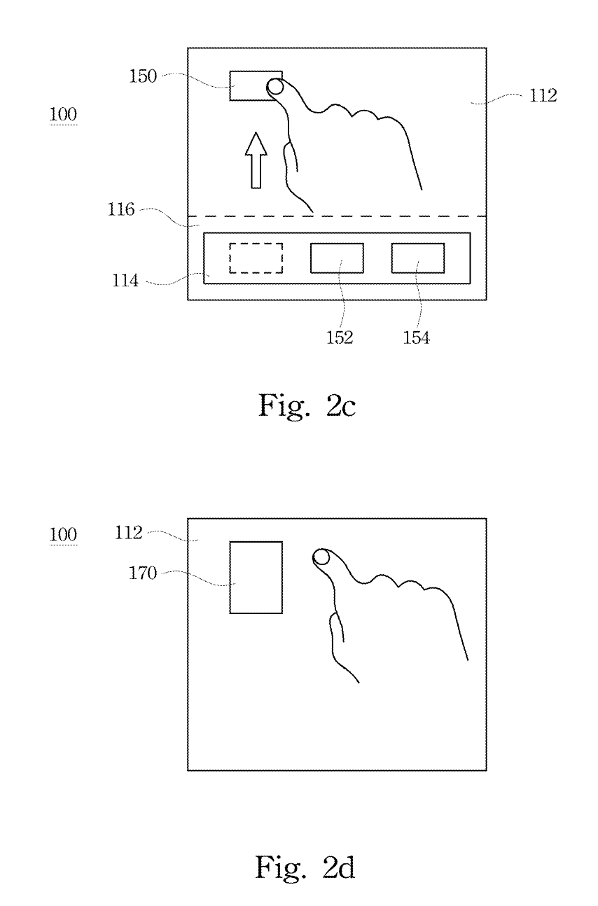

Please refer to FIGS. 2a-2c. In the following embodiments, the screen 110 is a touch screen, the user interface module 130 is a touch sensing module, and the pointer is a user's finger. Those skilled in the art will appreciate that the touch screen and the user's finger are illustrative only and is NOT intended to be in any way limiting. For example, if the screen 110 is the touch screen, the user interface module 130 senses that the entity or the stylus touches thereon and thereby generates the first, second, and third sensing signals. It should be noted that the pointer is not necessary to be a graphic cursor displayed on the screen 110.

If the screen 110 is the non-touch screen, the user interface module 130 could be a mouse or a touch pad which can control the pointer's movement. Alternatively, an image capture apparatus captures the user's gesture and then analyzes image variation to generate a control signal for controlling the pointer's movement.

In use, as shown in FIG. 2a, when the pointer is positioned on the executing window 114, the user interface module 130 generates the first sensing signal, and the executing window 114 displays items 150, 152 and 154. The items 150, 152 and 154 correspond to different user interfaces respectively.

As shown in FIG. 2b, when the pointer selects the item 150, the user interface module 130 generates the second sensing signal. In this embodiment, the enlarged item 150 represents that the item 150 is selected.

As shown in FIG. 2c, when the pointer drags the item 150 to the working window 112, the user interface module 130 generates the third sensing signal.

As shown in FIG. 2d, if the processing module 120 continuously receives the first, second and third sensing signals, the processing module 120 can open a user interface 170 corresponding to the item in the working window 112, wherein the user interface 170 is adjacent to the pointer.

Furthermore, the processing module 120 opens the user interface corresponding to the item 150 in a predetermined window range. The predetermined window range may be equal to the entire display region of the screen 110, so that the processing module 120 can open the user interface 170 in full screen mode.

In this way, the user moves the pointer to the executing window 114 to select the item 150 and then drags the item 150 to the working window 112 for opening the user interface 170. This operating manner conforms to ergonomics, so as to provide convenience in use.

For a more complete understanding of opening the user interface and the interaction between the screen 110, the user interface module 130, and the processing module 120, the description will be made as to the first, second and third embodiments of the present disclosure in conjunction with the accompanying drawings.

### First Embodiment

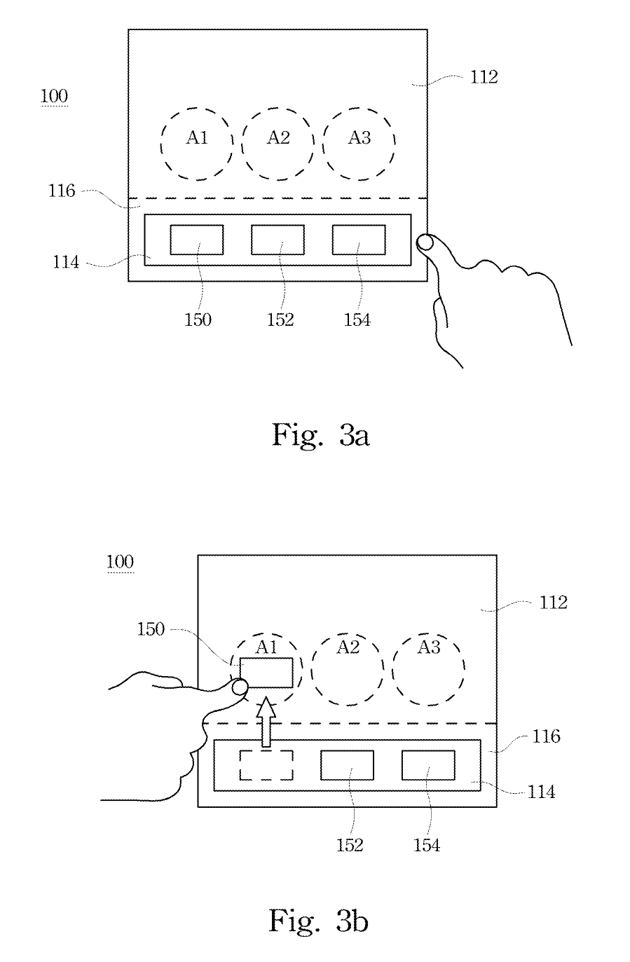

As shown in FIG. 3a, in the screen 110, the working window presets trigger positions A1, A2 and A3 corresponding to the item 150, 152 and 154 respectively. The third sensing signal is generated when the pointer drags the selected item 150 to the trigger position A1.

As shown in FIG. 3b, the pointer is positioned on the executing window 114 to select the item 150 and drags the item 150 to the trigger position A1, sequentially. Then, the processing module 120 continuously receives the first, second and third sensing signals to open the user interface (not shown) corresponding to the item 150 in the working window 112, wherein the user interface is adjacent to the pointer.

In the first embodiment, the screen 110 has the preset trigger positions A1, A2 and A3. Therefore, the processing module 120 opens the user interface corresponding to the item 150, where the user interface is adjacent to the trigger position A1. It should be appreciated that foresaid three trigger positions A1, A2 and A3 corresponding to the items 150, 152 and 154 illustrated in FIG. 3a are only examples and should not be regarded as limitations of the present invention. For example, a single trigger position may be preset in the screen 110, so that the pointer drags the items 150, 152 or 154 to this single trigger position for opening the corresponding user interface. Those with ordinary skill in the art may choose one or more trigger positions and/or may adjust the relation between the item and the trigger position depending on the desired application.

### Second Embodiment

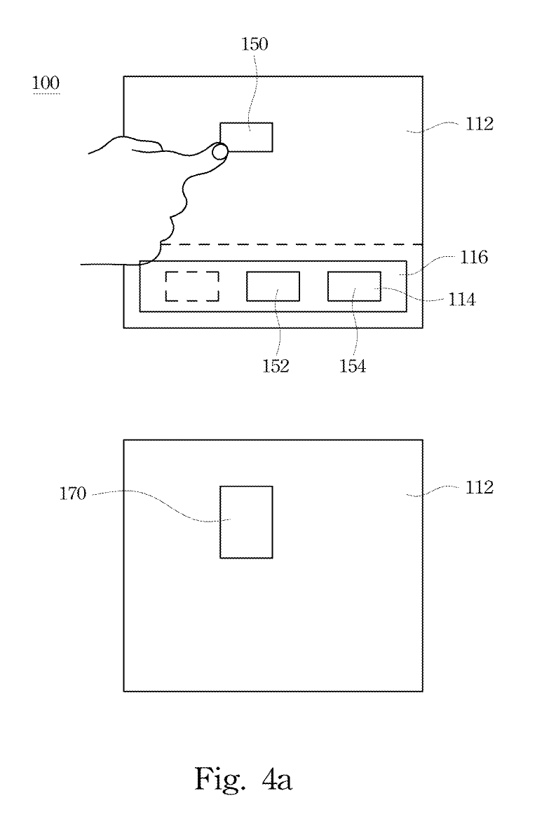

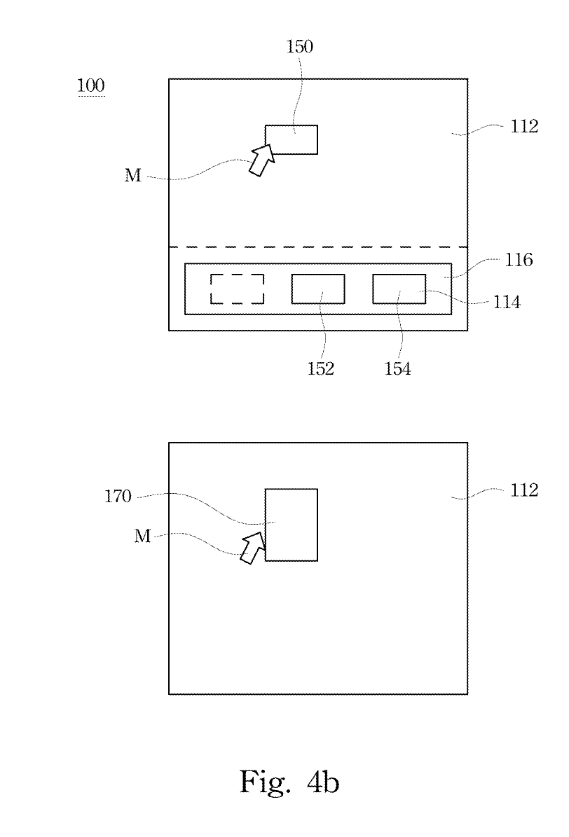

In the second embodiment, when determining that the pointer is positioned on the executing window 114 and selects the item 150, the user interface module 130 generates the first and second sensing signals. As shown in FIG. 4a, after the pointer drags the item 150 to the working window 112, the user interface module 130 generates the third sensing signal when the pointer stops controlling the item 150 in the working window 112 by touch, so that the processing module 120 continuously receives the first, second and third sensing signals to open the user interface corresponding to the item 150.

As shown in FIG. 4a, the screen 110 is a touch screen, and the pointer is controlled by the user's finger. When the pointer (finger) drags the item 150 on the working window 112 and then moves away from the screen 110, this action means that the pointer stops dragging the item 150, and the user interface module 130 generates the third sensing signal. Alternatively, the action for stopping dragging the item 150 may be that the pointer (finger) drags the item on the working window and then ceases moving the item over a predetermined period, such as 2 seconds.

As shown in FIG. 4b, the screen 110 is a non-touch screen, and the pointer M is controlled by a mouse. When the pointer M (mouse) drags the item 150 on the working window 112 and then ceases moving the item over a predetermined period, such as 2 seconds, the user interface module 130 generates the third sensing signal, wherein during predetermined period, the pointer stops dragging the item.

### Third Embodiment

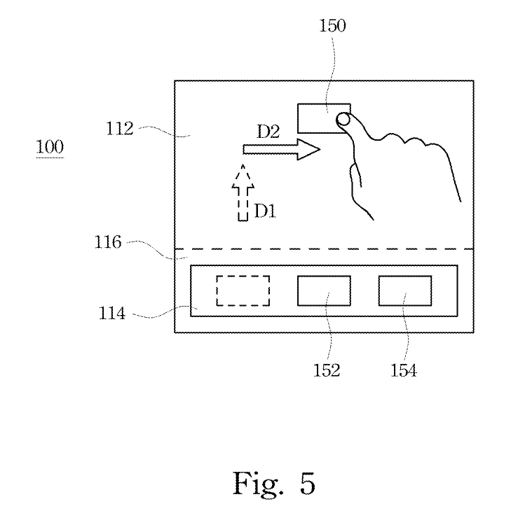

In the third embodiment, the conditions for generating the first and second signals are disclosed in the first and second embodiments and, thus, are not repeated herein. As shown in FIG. 5, when the pointer drags the item 150 and changes a direction for dragging the item 150, the user interface module 130 generates the third sensing signal, so that the processing module 120 continuously receives the first, second and third sensing signals to open the user interface (not shown) corresponding to the item 150.

In practice, when the pointer drags the item from a first direction to a second direction, and when an included angle between the first and second directions is larger than 90°, the user interface module 130 generates the third sensing signal. If the included angle is less than 90°, the pointer may move back on the executing window 114; this motion signifies the user doesn't want to open the user interface corresponding to the item. Therefore, the included angle being larger than 90° conforms to ergonomics, so as to facilitate operation.

The processing module 120 may be hardware, software, and/or firmware. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

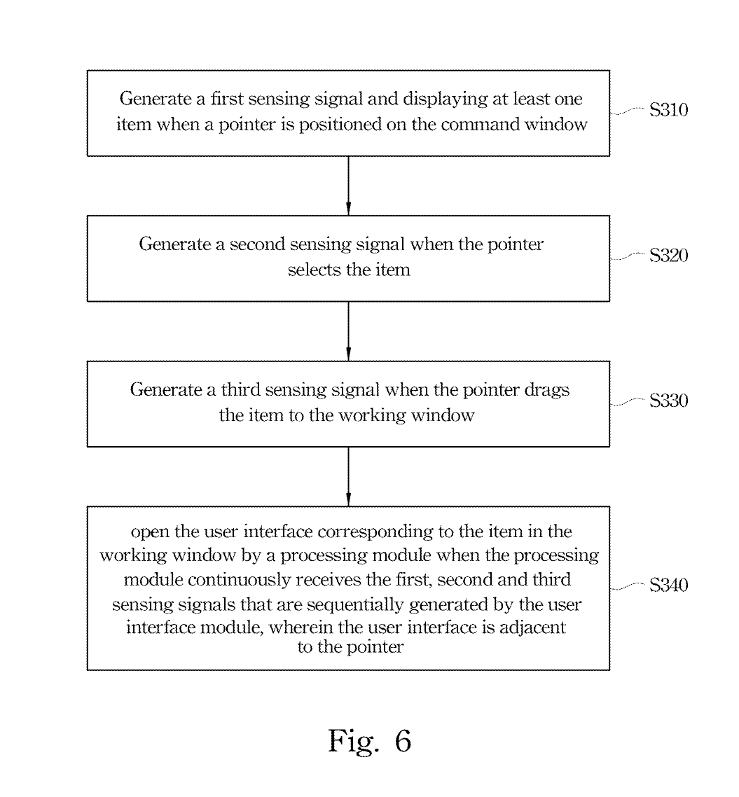

FIG. 6 is a flowchart of a method for opening the user interface on the screen according to one or more embodiments of the present invention. The screen is capable of displaying a working window and an executing window. The user interface module 130 is capable of generating first, second, and third sensing signals, and the method comprises steps S310-S340 as follows (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step S310, when a pointer is positioned on the executing window, the first sensing signal is generated, and at least one item is displayed;

In step S320, when the pointer selects the item, the second sensing signal is generated;

In step S330, when the pointer drags the item to the working window, a third sensing signal is generated; and

In step S340, when a processing module continuously receives the first, second and third sensing signals that are sequentially generated by the user interface module, a user interface corresponding to the item is opened in the working window, where the user interface is adjacent to the pointer.

In this method, first, second and third operating modes are proposed in accordance with the foresaid first, second and third embodiments with regard to the electronic device. In the first operating mode, at least one trigger position is preset in the working window, and the third sensing signal is generated when the pointer drags the item to the trigger position. In the second operating mode, the third sensing signal is generated when the pointer stops dragging the item. In the third operating mode, the third sensing signal is generated when the pointer drags the item and changes the direction for dragging the item. Therefore, the processing module continuously receives the first, second and third sensing signals to open the user interface corresponding to the item, wherein the user interface is adjacent to the pointer. The more detail of the first, second and third operating modes are disclosed in the above first, second and third embodiments and, thus, are not repeated herein.

The foresaid method may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

In view of above, technical advantages are generally achieved, by one or more embodiments of the present invention, as follows:

1. The user can intuitively open the user interface corresponding to the item by means of dragging this selected item; and

2. The user can intuitively drag the item to the working window and then open the user interface corresponding to the item by means of dragging the item to the trigger position, stopping dragging the item or changing the direction for dragging the item.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. An electronic device, comprising:
a screen being capable of displaying a working window and an executing window,
a user interface module, wherein when a pointer is positioned on the executing window, the user interface module generates a first sensing signal for displaying at least one item on the screen, when the pointer selects the item, the user interface module generates a second sensing signal, and when the pointer drags the item to the working window, the user interface module generates a third sensing signal; and
a processing module for continuously receiving the first, second and third sensing signals that are sequentially generated by the user interface module to open a user interface corresponding to the item in the working window, wherein the user interface is adjacent to the pointer.

2. The electronic device of claim 1, wherein the processing module opens the user interface in a predetermined window range.

3. The electronic device of claim 1, wherein the screen is divided into two areas, the working window and the executing window are displayed in said two areas respectively.

4. The electronic device of claim 1, wherein the screen has a predetermined executing window area, the screen displays the working window and the executing window simultaneously when the pointer is positioned on the predetermined executing window area; the screen displays the working window when the pointer isn't positioned on the predetermined executing window area.

5. The electronic device of claim 4, wherein the executing window is overlapped on the working window.

6. The electronic device of claim 4, wherein the working window is reduced from a first district scope to a second district scope, so that the screen displays the working window and the executing window simultaneously.

7. The electronic device of claim 1, wherein the working window presets at least one trigger position, the user interface module generates the third sensing signal when the pointer drags the item to the trigger position, so that the processing module opens the user interface in the working window.

8. The electronic device of claim 1, wherein the screen is a non-touch screen, the user interface module generates the third sensing signal when the pointer stops dragging the item, so that the processing module opens the user interface in the working window.

9. The electronic device of claim 1, wherein the screen is a touch screen, the user interface module generates a third sensing signal when the pointer stops controlling the item by touch, so that the processing module opens the user interface in the working window.

10. The electronic device of claim 1, wherein when the pointer drags the item and changes a direction for dragging the item, the user interface module generates the third sensing signal, so that the processing module opens the user interface in the working window.

11. A method for opening a user interface on a screen, wherein the screen is capable of displaying a working window and an executing window, and a user interface module is capable of generating first, second, and third sensing signals, the method comprising:
(a) generating the first sensing signal and displaying at least one item when a pointer is positioned on the executing window;
(b) generating the second sensing signal when the pointer selects the item;
(c) generating the third sensing signal when the pointer drags the item to the working window; and
(d) opening the user interface corresponding to the item in the working window by a processing module when the processing module continuously receives the first, second and third sensing signals that are sequentially generated by the user interface module, wherein the user interface is adjacent to the pointer.

12. The method of claim 11, wherein the step (d) comprises:
opening the user interface in a predetermined window range by the processing module.

13. The method of claim 11, wherein the screen is divided into two areas, the working window and the executing window are displayed in said two areas respectively.

14. The method of claim 12, wherein the screen has a predetermined executing window area, the screen displays the working window and the executing window simultaneously when the pointer is positioned on the predetermined executing window area; the screen displays the working window when the pointer isn't positioned on the predetermined executing window area.

15. The method of claim 14, wherein the executing window is overlapped on the working window.

16. The method of claim 14, wherein the working window is reduced from a first district scope to a second district scope, so that the screen simultaneously displays the working window and the executing window.

17. The method of claim 11, wherein the step (c) comprises:
presetting at least one trigger position in the working window; and
generating the third sensing signal when the pointer drags the item to the trigger position.

18. The method of claim 11, wherein the screen is a non-touch screen, and the step (c) comprises:
generating the third sensing signal when the pointer stops dragging the item.

19. The method of claim 11, wherein the screen is a touch screen, and the step (c) comprises:
generating the third sensing signal when the pointer stops controlling the item by touch, wherein when the pointer drags the item on the working window and then ceases moving the item over a predetermined period, by the user interface module generating the third sensing signal, wherein the pointer stops dragging the item during predetermined period.

20. The method of claim 11, wherein the step (c) comprises:
generating the third sensing signal when the pointer drags the item and changes a direction for dragging the item.
